(19) United States
(12) Patent Application Publication
(10) Pub. No.: US 2018/0074529 A1
(43) Pub. Date: Mar. 15, 2018

(54) PRESSURE-REDUCING VALVE

(71) Applicant: AISAN KOGYO KABUSHIKI KAISHA, Obu-shi, Aichi-ken (JP)

(72) Inventors: Norihiko SHIGEOKA, Nagoya-shi (JP); Eiji SANO, Obu-shi (JP); Junichi KUMAKI, Tokai-shi (JP); Tametoshi MIZUTA, Toyota-shi (JP)

(73) Assignee: AISAN KOGYO KABUSHIKI KAISHA, Obu-shi, Aichi-ken (JP)

(21) Appl. No.: 15/560,058

(22) PCT Filed: Mar. 29, 2016
(86) PCT No.: PCT/JP2016/060058

§ 371 Date: Sep. 20, 2017

(30) Foreign Application Priority Data
Apr. 9, 2015 (JP) 2015-080129

(51) Int. Cl. G05D 16/10; F16K 31/122; F16K 17/04

(52) U.S. Cl. CPC G05D 16/103; F16K 17/04; F16K 31/122

(57) ABSTRACT

A pressure-reducing valve includes a valve chamber, a pressure regulating chamber, a partition member, which has a communication hole, and a valve body. The partition member includes the communication hole and a valve seat. The valve body includes a body portion and a rod portion. The valve seat includes a plurality of inclined surfaces, which have different inclination angles with respect to the central axis of the valve body. The circumference wall of the communication hole and the valve seat are connected by a coupling portion. The inclination angle of the valve seat is varied discretely such that the valve seat comes into contact with the valve body at a position more that is further the radially outward from the central axis of the valve body than the coupling portion.

### TECHNICAL FIELD

The present invention relates to a pressure-reducing valve that reduces the pressure of gas.

### BACKGROUND ART

Conventionally, a valve described in Patent Document 1, for example, has been proposed as one such pressure-reducing valve. FIG. 7 shows an example of the conventional pressure-reducing valve. As shown in FIG. 7, the conventional pressure-reducing valve includes a partition member 110, which separates a valve chamber 101 and a pressure regulating chamber 102 from each other. High-pressure gas flows into the valve chamber 101 from the upstream side of the pressure-reducing valve. The pressure regulating chamber 102 reduces the pressure of the gas. The partition member 110 has a communication hole 111, which allows communication between the interior of the valve chamber 101 and the interior of the pressure regulating chamber 102. The part of the partition member 110 that faces the valve chamber 101 functions as a valve seat 112.

A body portion 121 of a valve body 120, which selectively proceeds in the direction approaching the valve seat 112 and retreats in the direction separating from the valve seat 112, is located in the valve chamber 101. A rod portion 122 extends from the body portion 121 into the pressure regulating chamber 102 through the communication hole 111. The space between the circumferential wall of the communication hole 111 and the rod portion 122 of the valve body 120 is a communication passage 105, through which gas flows from inside the valve chamber 101 into the pressure regulating chamber 102.

In the pressure-reducing valve, when the pressure in the pressure regulating chamber 102 is excessively high, the rod portion 122 is retracted into the pressure regulating chamber 102. The body portion 121 of the valve body 120 is thus seated on the valve seat 112 of the partition member 110. When the body portion 121 is seated on the valve seat 112 in this manner, the valve body 120 closes the communication passage 105, thus restricting the gas flow from inside the valve chamber 101 into the pressure regulating chamber 102. By closing the communication passage 105 in this manner, the gas the pressure of which has been reduced is caused to flow downstream of the pressure-reducing valve.

When the pressure in the pressure regulating chamber 102 is excessively lowered through regulation of the gas flow from inside the valve chamber 101 into the pressure regulating chamber 102, the rod portion 122 is pushed back into the valve chamber 101 from inside the pressure regulating chamber 102. The body portion 121 of the valve body 120 is thus separated from the valve seat 112. When the body portion 121 of the valve body 120 is separated from the valve seat 112 in this manner, the communication passage 105 is open. The gas is thus caused to flow from inside the valve chamber 101 into the pressure regulating chamber 102 through the communication passage 105. As a result, the pressure of the gas is regulated.

### PRIOR ART DOCUMENT

### Patent Document

Patent Document 1: Japanese Laid-Open Patent Publication No. 2007-170432

### SUMMARY OF THE INVENTION

### Problems that the Invention is to Solve

As shown in FIG. 8, load acts on the valve seat 112 of the partition member 110 when the body portion 121 of the valve body 120 is seated on the valve seat 112. As shown in FIG. 9, the load may plastically deform the valve seat 112 of the partition member 110, thus projecting part of the circumferential wall of the communication hole 111 radially inward. This reduces the cross-sectional area of the communication passage 105 in the vicinity of the valve seat 112. In this case, turbulence occurs in the gas flow in the communication passage 105, thus increasing the pressure loss of the gas flowing in the communication passage 105. As a result, noise is likely to be generated by the pressure-reducing valve.

Accordingly, it is an objective of the present invention to provide a pressure-reducing valve capable of making it unlikely that noise will be generated by gas flowing in a communication passage.

### Means for Solving the Problems

To achieve the foregoing objective and in accordance with one aspect of the present invention, a pressure-reducing valve is provided that includes a valve chamber, into which a gas flows, a pressure regulating chamber, a partition member, a piston, a valve body, a body portion, a rod portion, a communication passage, and a valve seat. The pressure regulating chamber regulates a pressure of the gas. The partition member separates the valve chamber and the pressure regulating chamber from each other. The partition member has a communication hole, which allows communication between an interior of the valve chamber and an interior of the pressure regulating chamber. The piston is arranged to be opposed to the partition member with the pressure regulating chamber located between the piston and the partition member. The valve body has a central axis. The body portion is arranged in the valve body. The body portion is located in the valve chamber and configured to selectively move in a direction approaching the partition member and a direction separating from the partition member. The rod portion is arranged in the valve body. The rod portion extends between the piston and the body portion through the communication hole. The communication passage is provided between a circumferential wall of the communication hole and the rod portion. The communication passage allows communication between the valve chamber and the pressure regulating chamber. The valve seat is arranged in the partition member at a position opposed to the body portion. The communication passage is closed when the body portion is seated on the valve seat and is open when the body portion is separated from the valve seat. The valve seat has a plurality of inclined surfaces having different inclination angles with respect to the central axis of the valve body. The circumferential wall of the communication hole and the valve seat are coupled to each other at a coupling portion. An inclination angle of the valve seat is varied discretely such that the valve seat comes into contact with the valve body at a position that is further radially outward from the central axis of the valve body than the coupling portion.

### BRIEF DESCRIPTION OF THE DRAWINGS

FIG. 1 is a cross-sectional view showing a pressure regulating device including a pressure-reducing valve of one embodiment.

FIG. 2 is an enlarged cross-sectional view showing a section of the pressure-reducing valve of the embodiment.

FIG. 3 is a cross-sectional view showing a plastically deformed state of a valve seat of the pressure-reducing valve of the embodiment.

FIG. 4A is a graph representing the relationship between a pressure amplitude, which is the amplitude of pressure oscillation caused by gas fuel flowing in the communication passage, and the frequency in a pressure-reducing valve of a comparative example.

FIG. 4B is a graph representing the relationship between a pressure amplitude, which is the amplitude of pressure oscillation caused by gas fuel flowing in the communication passage, and the frequency in the pressure-reducing valve of the embodiment.

FIG. 5 is a cross-sectional view showing the configuration of a pressure-reducing valve of another embodiment.

FIG. 6 is a cross-sectional view showing the configuration of a pressure-reducing valve of another embodiment.

FIG. 7 is a cross-sectional view schematically showing the configuration of a conventional pressure-reducing valve.

FIG. 8 is an enlarged cross-sectional view showing a section of the conventional pressure-reducing valve.

FIG. 9 is a cross-sectional view showing a plastically deformed state of the valve seat of the conventional pressure-reducing valve.

### MODES FOR CARRYING OUT THE INVENTION

A pressure-reducing valve according to one embodiment will now be described with reference to the drawings. The pressure-reducing valve reduces the pressure of gas. The pressure-reducing valve is arranged in a fuel supply device that supplies compressed natural gas (CNG) as an example of gas fuel to an internal combustion engine.

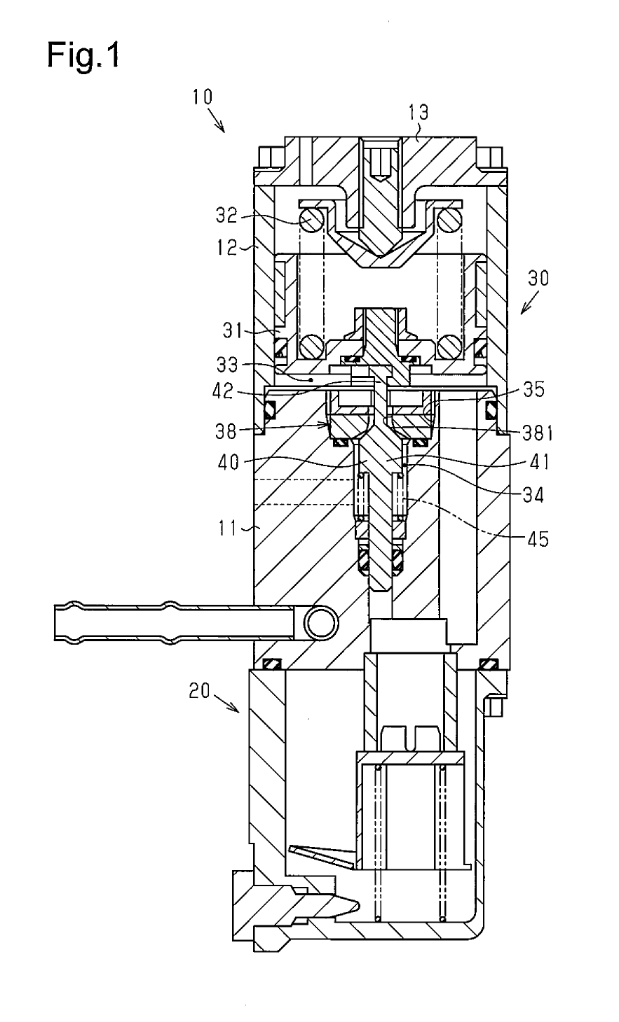

FIG. 1 shows a pressure regulating device 10, which includes a pressure-reducing valve 30 of the present embodiment.

As shown in FIG. 1, the pressure regulating device 10 includes a body 11, a tubular body 12, and a lid member 13. The tubular body 12 is arranged on top of the body 11 as viewed in the drawing. The lid member 13 closes the upper opening of the tubular body 12 as viewed in the drawing. An oil separator 20, which separates foreign matter such as oil from CNG after the pressure-reducing valve 30 reduces the pressure of the CNG to a specified pressure, is arranged below the body 11 as viewed in FIG. 1. After flowing out of the oil separator 20, the CNG is supplied to an internal combustion engine, which is located downstream of the pressure regulating device 10.

A piston 31 and a pressure regulating spring 32, which urges the piston 31 toward the body 11, or downward as viewed in FIG. 1, are arranged in the tubular body 12. The space between the piston 31 and the body 11 is a pressure regulating chamber 33, which reduces the pressure of high-pressure CNG to the specified pressure.

A valve chamber 34, into which the high-pressure CNG supplied from a fuel tank flows, is arranged in the body 11. A middle section 35, which opens in the upper surface of the body 11 as viewed in FIG. 1 and has a diameter greater than the diameter of the valve chamber 34, is arranged on the upper side of the valve chamber 34 in the body 11 as viewed in the drawing. A partition member 38, which separates the valve chamber 34 and the pressure regulating chamber 33 from each other, is arranged in the middle section 35.

A communication hole 381, which extends through the partition member 38 in the axial direction and allows communication between the interior of the valve chamber 34 and the interior of the pressure regulating chamber 33, is arranged in the partition member 38. The partition member 38 is arranged to be opposed to the piston 31 with the pressure regulating chamber 33 located between the partition member 38 and the piston 31.

A valve body 40 of the pressure-reducing valve 30 has a body portion 41, which is located in the valve chamber 34, and a rod portion 42, which extends from the body portion 41 into the pressure regulating chamber 33 through the communication hole 381. That is, the body portion 41 and the rod portion 42 are arranged in the valve body 40. The rod portion 42 extends between the piston 31 and the body portion 41. A valve chamber spring 45, which urges the body portion 41 toward the partition member 38, is arranged in the valve chamber 34 in which the body portion 41 is located. The body portion 41 is configured to selectively move in the direction approaching the partition member 38 and the direction separating from the partition member 38.

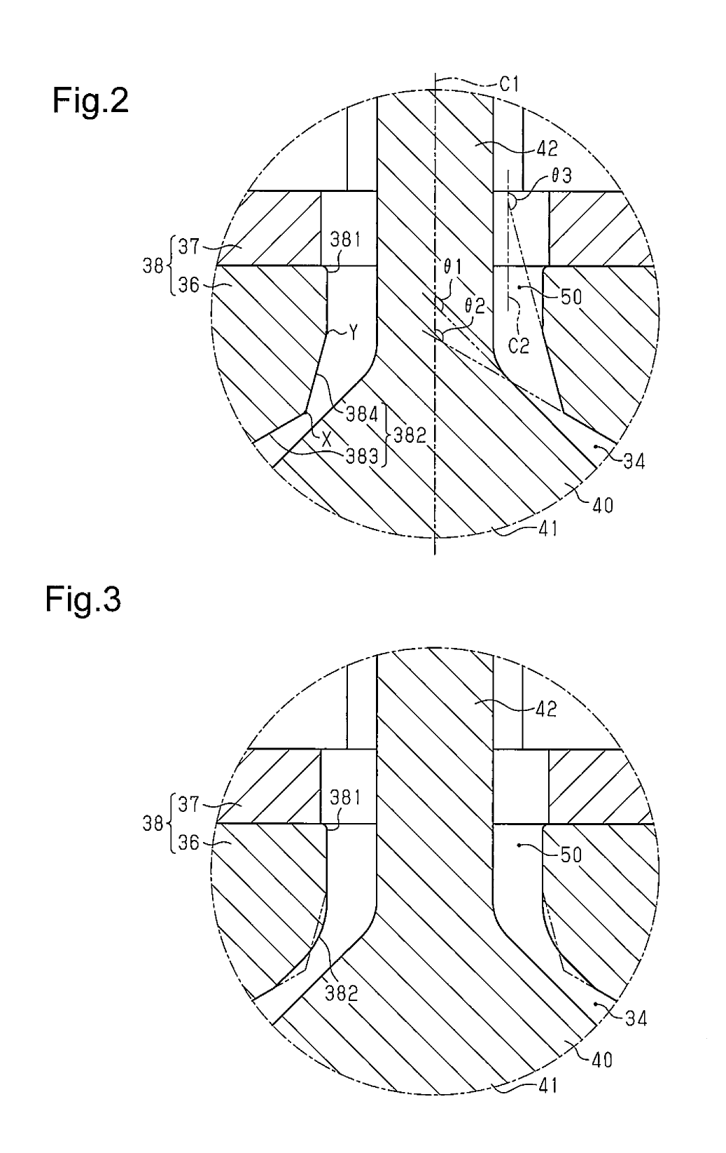

As shown in FIG. 2, the partition member 38 is configured by a seat 36, which has a circular shape as viewed from above in the axial direction, which is the up-down direction of the drawing, and a plug 37. The plug 37 restricts separation of the seat 36 from inside the middle section 35. The communication hole 381 is configured by a through-hole extending through the seat 36 and the plug 37. The part of the partition member 38 opposed to the body portion 41 of the valve body 40 is a valve seat 382, on which the body portion 41 of the valve body 40 becomes seated. That is, the part of the seat 36 opposed to the body portion 41 of the valve body 40 is the valve seat 382.

A communication passage 50, through which CNG flows from inside the valve chamber 34 into the pressure regulating chamber 33, is arranged between the rod portion 42 and the circumferential wall of the communication hole 381 of the partition member 38. When the body portion 41 of the valve body 40 is seated on the valve seat 382, the body portion 41 of the valve body 40 closes the communication passage 50, thus blocking the CNG flow from inside the valve chamber 34 into the pressure regulating chamber 33. In contrast, when the body portion 41 of the valve body 40 is separated from the valve seat 382, the CNG is caused to flow from inside the valve chamber 34 into the pressure regulating chamber 33 through the communication passage 50.

Specifically, the urging force by which the pressure regulating spring 32 urges the piston 31 is greater than the urging force by which the valve chamber spring 45 urges the valve body 40. When the pressure in the pressure regulating chamber 33 is lower than or equal to the specified pressure, the rod portion 42, which is coupled to the piston 31, is pushed back into the valve chamber 34 by the urging force of the pressure regulating spring 32. The body portion 41 of the valve body 40 is thus separated from the valve seat 382.

In contrast, when the pressure in the pressure regulating chamber 33 is higher than the specified pressure, the resultant of the pressure acting on the piston 31 and the urging force of the valve chamber spring 45 is greater than the urging force of the pressure regulating spring 32. This moves the rod portion 42 into the pressure regulating chamber 33. The body portion 41 of the valve body 40 is thus switched to a state seated on the valve seat 382.

As shown in FIG. 2, the valve seat 382 is configured by a first inclined surface 383 and a second inclined surface 384. The first inclined surface 383, which is located upstream in the CNG flow direction, and the second inclined surface 384, which is located downstream, have different inclination angles with respect to the central axis C1 of the valve body 40.

Specifically, the inclination angle θ2 of the first inclined surface 383 with respect to the central axis C1 is smaller than the inclination angle θ1 of the surface of the body portion 41 of the valve body 40 that contacts the valve seat 382. On the other hand, the inclination angle θ3 of the second inclined surface 384 with respect to the central axis C1 is greater than the inclination angle θ1. In FIG. 2, the long dashed double-short dashed passage C2, which is parallel to the central axis C1, represents the inclination angle θ3.

As has been described, the valve seat 382 of the pressure-reducing valve 30 of the present embodiment is configured by the two inclined surfaces (383, 384), which have the different inclination angles, and has a two-stepped tapered shape having a varying inclination angle.

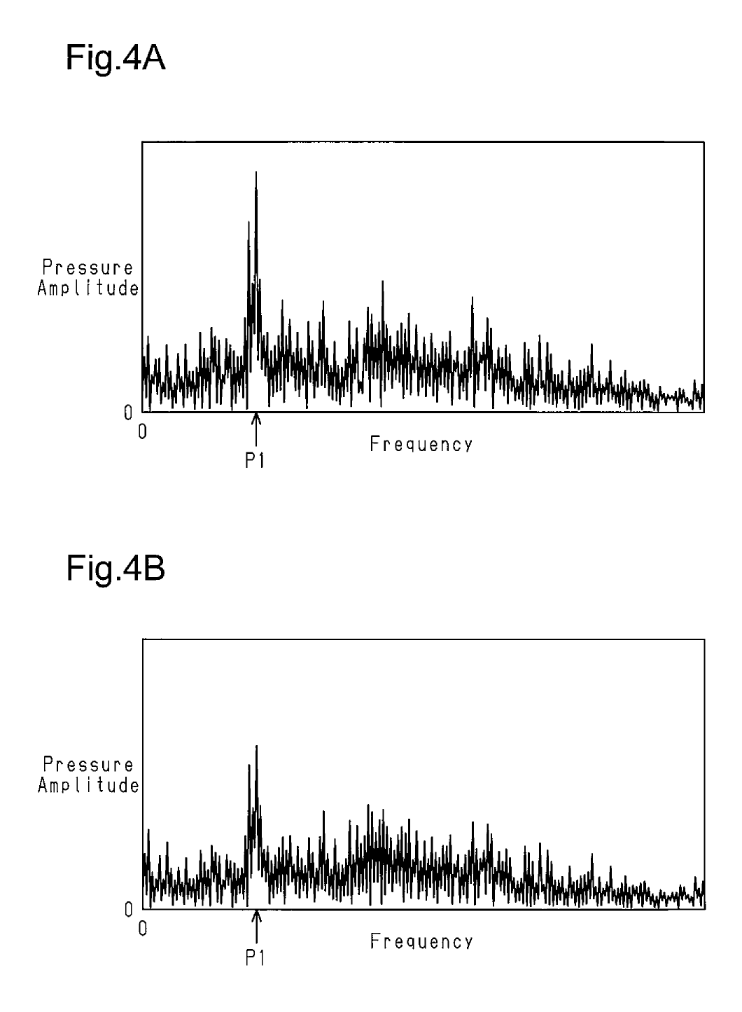

Next, with reference to FIGS. 3 and 4, operation of the pressure-reducing valve 30 of the present embodiment will be described. FIGS. 4A and 4B each represent the relationship between the amplitude (pressure amplitude) of pressure oscillation caused by the CNG flowing in the communication passage 50 and the frequency.

When the pressure in the pressure regulating chamber 33 is higher than the specified pressure, the pressure-reducing valve 30 retracts the rod portion 42 into the pressure regulating chamber 33. The body portion 41 of the valve body 40 is thus seated on the valve seat 382 of the partition member 38. When the body portion 41 is seated on the valve seat 382 in this manner, the valve body 40 closes the communication passage 50, thus restricting the gas flow from inside the valve chamber 34 into the pressure regulating chamber 33. By closing the communication passage 50 in this manner, the gas the pressure of which has been reduced is caused to flow downstream of the pressure-reducing valve 30.

When the pressure in the pressure regulating chamber 33 is lowered to a value lower than or equal to the specified pressure through restriction of the gas flow from inside the valve chamber 34 into the pressure regulating chamber 33, the rod portion 42 is pushed back from inside the pressure regulating chamber 33 into the valve chamber 34. The body portion 41 of the valve body 40 is thus separated from the valve seat 382. When the body portion 41 of the valve body 40 is separated from the valve seat 382 in this manner, the communication passage 50 is open. The gas is thus caused to flow from inside the valve chamber 34 into the pressure regulating chamber 33 through the communication passage 50. The pressure of the gas is thus regulated.

In the pressure-reducing valve 30 of the present embodiment, the valve seat 382 is configured by the first inclined surface 383, the inclination angle of which is smaller than the inclination angle θ1 of the body portion 41, and the second inclined surface 384, the inclination angle of which is greater than the inclination angle θ1 of the body portion 41. As a result, when the body portion 41 becomes seated on the valve seat 382, the valve seat 382 and the body portion 41 come into contact with each other at a joint portion X between the first inclined surface 383 and the second inclined surface 384. That is, the inclination angle of the valve seat 382 is varied discretely such that the valve seat 382 and the body portion 41 come into contact with each other at a position that is further radially outward from the central axis C1 than a coupling portion Y between the circumferential wall of the communication hole 381 and the valve seat 382.

The joint portion X extends on the surface of the valve seat 382 in a circular shape to surround the central axis C1. As a result, when the body portion 41 of the valve body 40 is seated on the valve seat 382, the body portion 41 and the valve seat 382 are in line contact with each other.

When the body portion 41 of the valve body 40 becomes seated on the valve seat 382 of the seat 36, load may act to plastically deform the valve seat 382.

FIG. 3 shows a plastically deformed state of the valve seat 382 brought about by the load caused by seating of the body portion 41. As has been described, the part of the valve seat 382 that contacts the body portion 41 of the valve body 40 is located at a position that is further radially outward than the coupling portion Y coupled to the circumferential wall of the communication hole 381. As a result, even if the valve seat 382 is plastically deformed by the load caused by seating of the body portion 41 of the valve body 40, such deformation is unlikely to influence the interior of the communication passage 50 and the cross-sectional area of the communication passage 50 is unlikely to be reduced.

That is, the pressure-reducing valve 30 of the present embodiment restrains reduction in the cross-sectional area of the communication passage 50 when the valve seat 382 is plastically deformed. As a result, even if the valve seat 382 is plastically deformed, turbulence is unlikely to occur in the gas flow in the communication passage 50. The pressure loss of the gas flowing in the communication passage 50 is thus unlikely to increase.

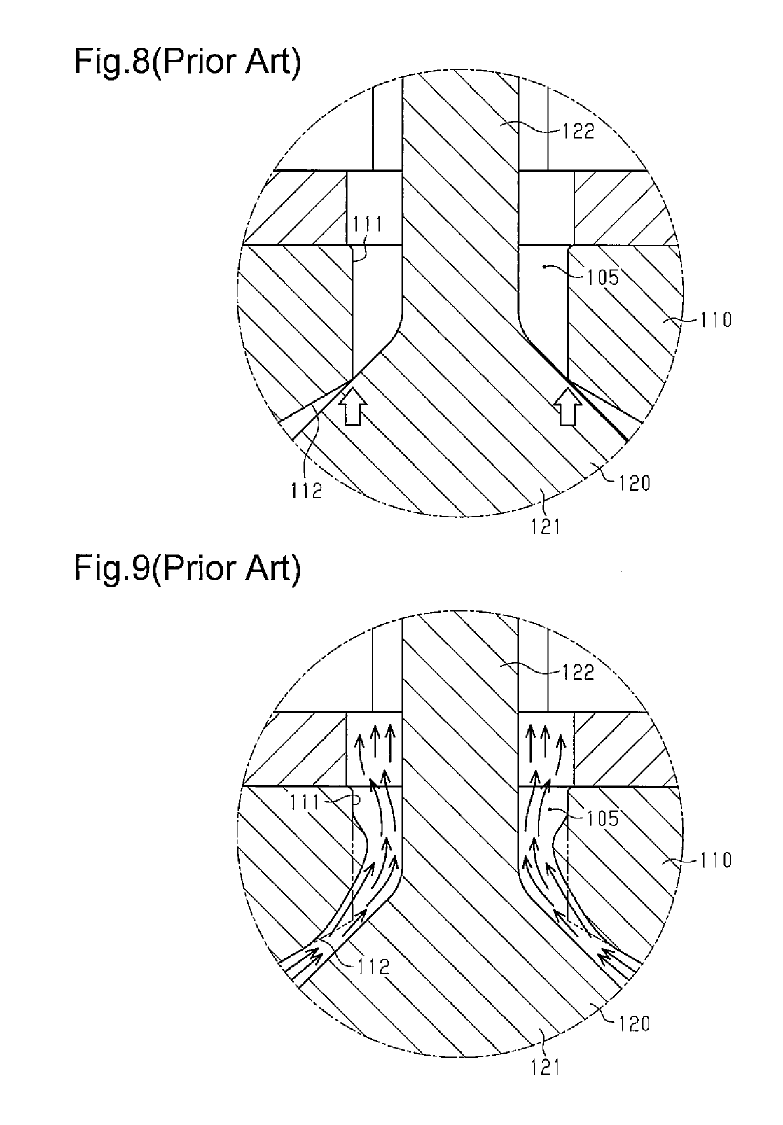

Specifically, as shown in FIG. 8, for example, in the pressure-reducing valve of the comparative example, in which the valve seat 112 is constituted solely by an inclined surface having an inclination angle smaller than the inclination angle of the contact surface of the body portion 121 of the valve body 120, part of the circumferential wall of the communication hole 111 projects radially inward as shown in FIG. 9. This reduces the cross-sectional area of the communication passage 105. As a result, turbulence is likely to occur in the CNG flow in the communication passage 105. The pressure loss of the CNG flowing in the communication passage 105 is thus likely to increase, thus promoting noise generation.

For example, as shown in FIG. 4A, the pressure-reducing valve of the comparative example exhibits a peak with great pressure amplitude at frequency P1. The pressure-reducing valve thus generates noise having the frequency P1.

In contrast, as shown in FIG. 3, in the pressure-reducing valve 30 of the present embodiment, even when the valve seat 382 is plastically deformed, the circumferential wall of the communication hole 381 does not project radially inward and the cross-sectional area of the communication passage 50 is not reduced. The turbulence of the CNG flow caused by the plastic deformation of the valve seat 382 is thus unlikely to occur in the communication passage 50. This generally reduces the pressure amplitude as represented in FIG. 4B, compared to the comparative example. Particularly, in this case, the peak at the frequency P1 is low, indicating that the noise at the frequency P1 is effectively restrained.

A method of determining the location of the joint portion X will now be described.

The more radially outward the position of the joint portion X compared to the coupling portion Y, the less pronounced becomes the influence of plastic deformation of the valve seat 382 on the communication passage 50. In the pressure-reducing valve 30 of the present embodiment, the joint portion X, which contacts the body portion 41, is arranged at such a position that, even when the valve seat 382 is plastically deformed by the load caused by seating of the body portion 41, the cross-sectional area of the communication passage 50 is not reduced. In other words, the joint portion X is arranged at such a position that, even when the valve seat 382 is plastically deformed by the load caused by seating of the body portion 41, the cross-sectional area of the communication passage 50 is maintained.

The position of the joint portion X can be changed by adjusting the inclination angle θ2 and length of the first inclined surface 383 and/or the inclination angle θ3 and length of the second inclined surface 384. To design the pressure-reducing valve 30, tests are repeatedly carried out using different inclination angles θ2 and lengths for the first inclined surface 383 and different inclination angles θ3 and lengths for the second inclined surface 384. In this manner, the position at which the cross-sectional area of the communication passage 50 is not reduced regardless of plastic deformation of the valve seat 382 is determined.

By determining the location of the joint portion X in the above-described manner, reduction in the cross-sectional area of the communication passage 50 caused by plastic deformation of the valve seat 382 is restrained, as shown in FIG. 3.

The pressure-reducing valve 30 of the above-described embodiment achieves the following advantages.

(1) Reduction in the cross-sectional area of the communication passage 50 is restrained when the valve seat 382 is plastically deformed. As a result, even when the valve seat 382 is plastically deformed, turbulence is unlikely to occur in the gas flow in the communication passage 50 and the pressure loss of the gas flowing in the communication passage 50 is unlikely to increase. Noise is thus unlikely to be generated by the gas flowing in the communication passage 50.

(2) The body portion 41 of the valve body 40 and the valve seat 382 come into line contact with each other. In a case in which a body portion of a valve body and a valve seat come into surface contact with each other to seal the gap between the valve body and the valve seat, a sufficient surface area cannot be ensured in the sealing surfaces if the contact surface of the body portion and the contact surface of the valve seat are even slightly offset from each other. Desired sealing performance thus cannot be ensured. To avoid this, the part of the valve seat and the part of the body portion that contact each other must be machined with extremely high accuracy.

In contrast, in a case in which a body portion of a valve body and a valve seat come into line contact with each other to seal the gap between the valve body and the valve seat, ensuring sufficient sealing performance is facilitated compared to the case of the surface contact. As a result, the above-described pressure-reducing valve 30 facilitates ensuring sufficient sealing performance.

(3) In the pressure-reducing valve 30, the body portion 41 of the valve body 40 repeatedly comes into contact with the valve seat 382 and the valve seat 382 becomes plastically deformed as shown in FIG. 3. This increases the contact area of the sealing surfaces, thus further improving the sealing performance. That is, in the pressure-reducing valve 30, through plastic deformation of the valve seat 382 that occurs during use, the valve body 40 and the valve seat 382 are allowed to fit each other and the sealing performance is further improved.

That is, as has been described, in the pressure-reducing valve 30, when the valve seat 382 has not been plastically deformed, the body portion 41 of the valve body 40 and the valve seat 382 come into line contact with each other. This facilitates ensuring sufficient sealing performance even at the initial stage despite manufacturing tolerances, if any, in the respective components. Additionally, when plastic deformation occurs and allows the valve body 40 and the valve seat 382 to fit each other, the contact area increases, thus further improving the sealing performance.

(4) In a case in which a body portion of a valve body contacts a joint portion between two adjacent inclined surfaces, two inclined surfaces are sufficient for a valve seat. Therefore, the above-described pressure-reducing valve 30 brings about the configuration in which the body portion of the valve body contacts the joint portion between the two adjacent inclined surfaces through a maximally simplified configuration.

(5) The joint portion X is arranged at such a position that, even when the valve seat 382 is plastically deformed by the load caused by seating of the body portion 41, the cross-sectional area of the communication passage 50 is not reduced. This makes it unlikely that the cross-sectional area of the communication passage 50 will be reduced through plastic deformation of the valve seat 382. Noise generated by the gas flowing in the communication passage 50 is thus effectively restrained.

The above described embodiment may be modified as follows.

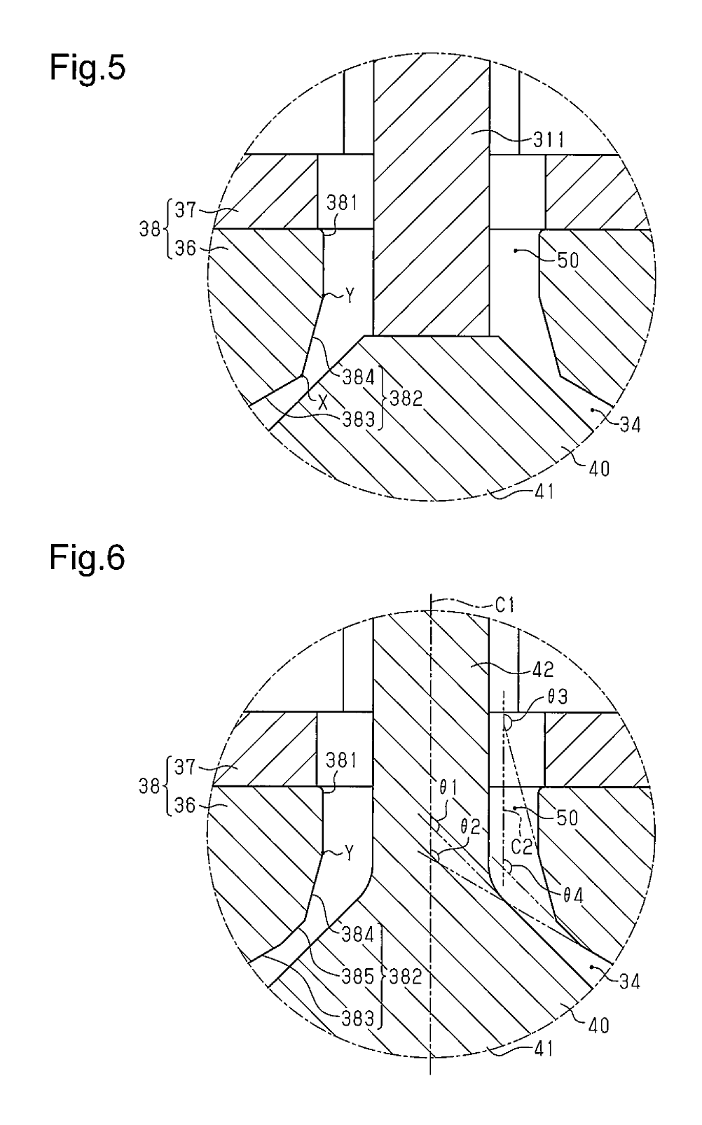

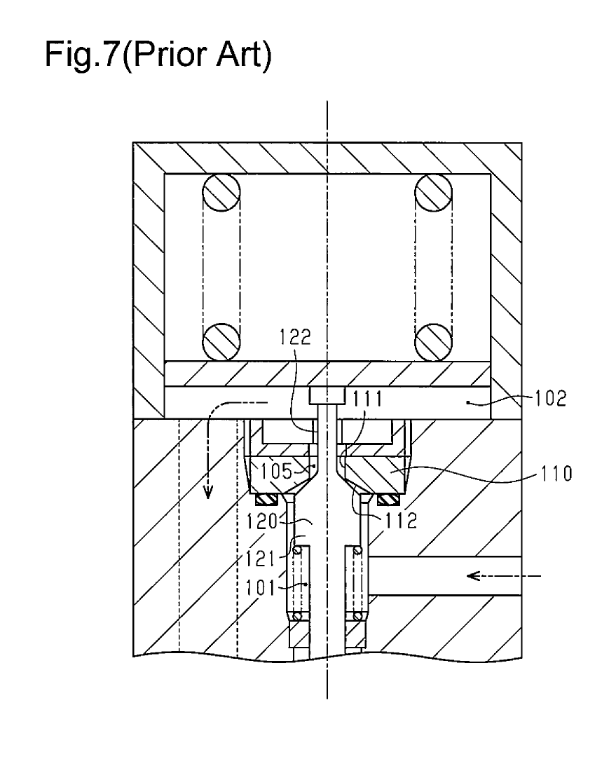

The pressure-reducing valve 30 of the above-described embodiment is configured such that the rod portion 42 extends from the body portion 41 of the valve body 40 toward the piston 31 through the communication hole 381. However, the pressure-reducing valve 30 may be configured in any other manner as long as the pressure-reducing valve 30 has a rod portion that extends through the communication hole 381. For example, as shown in FIG. 5, the pressure-reducing valve may be configured such that the piston has a rod portion 311, which extends toward the body portion 41 of the valve body 40 through the communication hole 381. In this case, the distal end of the rod portion 311 contacts the body portion 41 of the valve body 40. Also in this configuration, an advantage similar to the advantage (1) is obtained by configuring the valve seat 382 by multiple inclined surfaces and arranging the joint portion X radially outward of the coupling portion Y.

Alternatively, the pressure-reducing valve may be configured such that the body portion 41 of the valve body 40 has a rod portion that extends toward the piston 31 and that the piston 31 has a rod portion that extends toward the rod portion of the body portion 41. In this case, the distal ends of the two rod portions contact each other in the communication hole 381. Also in this configuration, an advantage similar to the advantage (1) is obtained by configuring the valve seat 382 by multiple inclined surfaces and arranging the joint portion X radially outward of the coupling portion Y.

Although the pressure-reducing valve 30 with the valve seat 382 having the two-stepped tapered shape has been illustrated, the number of the inclined surfaces that configure the valve seat 382 is not restricted to two. A valve seat 382 that has a multi-step tapered shape including three or more steps may be employed. Even in a case in which the valve seat 382 that has a multi-step tapered shape including three or more steps is employed, an advantage similar to the advantage (1) is obtained by configuring the valve seat 382 by multiple inclined surfaces and causing the valve seat 382 to contact the body portion 41 at a position radially outward of the coupling portion Y.

In a case in which the multi-step tapered shape including three or more steps is employed, the invention is not restricted to a configuration in which the body portion 41 of the valve body 40 comes into contact with a joint portion between two adjacent inclined surfaces. For example, as shown in FIG. 6, a third inclined surface 385, which is parallel to the contact surface of the body portion 41 of the valve body 40, may be arranged between the first inclined surface 383 and the second inclined surface 384 to allow surface contact between the body portion 41 and the valve seat 382.

That is, in this configuration, the inclination angle θ4 of the third inclined surface 385 with respect to the central axis C1 is equal to the inclination angle θ1. The body portion 41 of the valve body 40 thus contacts the third inclined surface 385 of the valve seat 382. Also in this case, the body portion 41 and the valve seat 382 contact each other at a position radially outward of the coupling portion Y, thus ensuring an advantage similar to the advantage (1).

The pressure-reducing valve may be embodied as a pressure-reducing valve arranged in a passage in which any gas other than CNG flows.

In the above-described embodiment, the joint portion X is illustrated, by way of example, as arranged at such a position that, even when the valve seat 382 is plastically deformed by the load caused by seating of the body portion 41, the cross-sectional area of the communication passage 50 is not reduced. However, the position of the part of the valve seat 382 that contacts the body portion 41 of the valve body 40 is not restricted to the illustrated position. As long as the part of the valve seat 382 that contacts the body portion 41 of the valve body 40 is located radially outward of the coupling portion Y, the amount by which the circumferential wall of the communication hole is deformed to project radially inward is reduced compared to the corresponding amount of the configuration of the comparative example, in which the valve seat contacts the coupling portion Y. As a result, noise generated by the gas flowing in the communication passage is restrained.

1. A pressure-reducing valve comprising:
a valve chamber, into which a gas flows;
a pressure regulating chamber, which regulates a pressure of the gas;
a partition member, which separates the valve chamber and the pressure regulating chamber from each other, wherein the partition member has a communication hole, which allows communication between an interior of the valve chamber and an interior of the pressure regulating chamber;
a piston, which is arranged to be opposed to the partition member with the pressure regulating chamber located between the piston and the partition member;
a valve body, which has a central axis;
a body portion, which is arranged in the valve body, wherein the body portion is located in the valve chamber and configured to selectively move in a direction approaching the partition member and a direction separating from the partition member;
a rod portion, which is arranged in the valve body, wherein the rod portion extends between the piston and the body portion through the communication hole;
a communication passage, which is provided between a circumferential wall of the communication hole and the rod portion, wherein the communication passage allows communication between the valve chamber and the pressure regulating chamber; and
a valve seat, which is arranged in the partition member at a position opposed to the body portion, wherein
the communication passage is closed when the body portion is seated on the valve seat and is open when the body portion is separated from the valve seat,
the valve seat has a plurality of inclined surfaces having different inclination angles with respect to the central axis of the valve body,
the circumferential wall of the communication hole and the valve seat are coupled to each other at a coupling portion, and
an inclination angle of the valve seat is varied discretely such that the valve seat comes into contact with the valve body at a position that is further radially outward from the central axis of the valve body than the coupling portion.

2. The pressure-reducing valve according to claim 1, wherein the valve seat is configured to come into contact with the body portion of the valve body at a joint portion between two adjacent inclined surfaces having different inclination angles with respect to the central axis of the valve body.

3. The pressure-reducing valve according to claim 2, wherein
an upstream-side inclined surface of the two adjacent inclined surfaces has a smaller inclination angle with respect to the central axis of the valve body than a contact surface of the body portion, and
a downstream-side inclined surface of the two adjacent inclined surfaces has a greater inclination angle with respect to the central axis of the valve body than the contact surface of the body portion.

4. The pressure-reducing valve according to claim 3, wherein the valve seat is constituted by two inclined surfaces having different inclination angles.

5. The pressure-reducing valve according to claim 2, wherein the joint portion, which contacts the body portion, is arranged at such a position that, even if the valve seat is plastically deformed by a load caused by seating of the body portion, a cross-sectional area of the communication passage is maintained.
